(19) United States
(12) Patent Application Publication
(10) Pub. No.: US 2026/0099798 A1
(43) Pub. Date: Apr. 9, 2026

(54) INTEGRATION OF CONVERSATIONAL ARTIFICIAL INTELLIGENCE WITH ENTERPRISE RESOURCE PLANNING SYSTEM TO AUTOMATE COLLECTIONS INQUIRIES VIA VOICE AND CHAT INTERFACES USING INTEGRATED PROGRAMMATIC AND SPECIALIZED GUIDED AND CONSTRAINED ARTIFICIAL INTELLIGENCE

(71) Applicant: Trilogy Enterprises, Inc., Austin, TX (US)

(72) Inventors: Arthur Michel, Brooklyn, NY (US); Colin Guilfoyle, Drogheda (IE)

(73) Assignee: Trilogy Enterprises, Inc., Austin, TX (US)

(21) Appl. No.: 19/352,327

(22) Filed: Oct. 7, 2025

Related U.S. Application Data
(60) Provisional application No. 63/704,524, filed on Oct. 7, 2024.

(51) Int. Cl. G06Q 10/067

(52) U.S. Cl. CPC G06Q 10/067

(57) ABSTRACT

A method and system for guiding an artificial intelligence (AI) engine to process customer inquiries regarding financial information and provide a response to the customer. The system and method receive a customer inquiry related to a financial issue through a communication interface, which could be a voice or chat interface. The received inquiry is analyzed by a natural language processing (NLP) module to determine the intent associated with the inquiry. A prompt generator is used to dynamically generate a prompt for requesting financial data, with the prompt being populated with information relevant to the determined intent based on predefined templates for the financial inquiry. The generated prompt is provided to the AI engine, which analyzes the prompt to determine whether the provided information is sufficient to generate an application programming interface (API) request for a financial management system to receive a response from a database to respond to the inquiry.

### CROSS-REFERENCE TO RELATED APPLICATION(S)

This application claims the benefit under 35 U.S.C. § 119(e) and 37 C.F.R. § 1.78 of U.S. Provisional Application No. 63,704,524, which are incorporated by reference in its entirety.

### FIELD OF THE INVENTION

The present invention relates in general to the field of electronics, and more specifically to systems and methods for processing customer inquiries related to financial information in real-time.

### BACKGROUND

Historically, managing customer service inquiries for financial matters like checking invoice balances or obtaining payment links has been a labor-intensive and time-consuming task. In the past, when the customer needed to inquire about financial information such as invoice balances, payment links, or similar details, the process began with the customer initiating contact with the service provider. Typically, customers would reach out through traditional communication channels, including phone calls or emails. Phone calls are the most common means, where customers dial a customer service number and wait to be connected to a representative. Alternatively, customers send an email, laying out their specific query and awaiting a response. The choice of the communication channels came with its own set of limitations. The phone calls often involved long wait times, especially during peak hours, resulting in customer frustration. On the other hand, emails, while more flexible in timings, required customers to wait for a response that could take hours, if not days. This initiation step was often cumbersome for customers, as they had to invest significant time and effort merely to start the process of resolving their inquiries. The manual nature of this step meant that customers had little visibility into when their request would be addressed.

Once the customer made contact, a customer service representative (CSR) manually handled the inquiry. The CSR acts as the bridge between the customer and the financial data stored within the company's internal systems. Upon receiving the customer's request, the CSR had to gather the relevant information, which typically required accessing multiple systems or databases. For example, if the customer inquired about an invoice balance, the CSR would need to search for the customer's account details, locate the specific invoice, and extract the required information. This step was labor-intensive and highly dependent on the skills and experience of the CSR. Additionally, the CSR often had to juggle multiple customer requests simultaneously, increasing the likelihood of mistakes and slowing down the overall process. The manual handling of customer inquiries hinders in delivery of timely and accurate financial information. After retrieving the necessary information, the CSR formulated a response that could be communicated back to the customer.

Moreover, the quality and accuracy of the response were heavily reliant on the CSR understanding of the financial data. If the CSR misinterpreted the figures or overlooked critical details, it could lead to incorrect or incomplete information being shared with the customer. Such errors not only undermined the customer's trust in the service provider but also created additional work, as follow-up queries and corrections would be required. The manual nature of response formulation therefore introduced a significant margin for error, impacting both the effectiveness and efficiency of customer service operations. Moreover, customer inquiries could only be addressed during business hours when CSR is on duty. This limitation was particularly problematic for businesses that served customers across multiple time zones, as it meant that customers outside of regular working hours had to wait until the next business day for a response.

Furthermore, the manual nature of the process introduced a higher likelihood of errors, which only compounded the delays. If the CSR provided incorrect information, the customer would need to reach out again to clarify or correct the issue, restarting the entire process. This cycle of inefficiency created a negative feedback loop, where errors led to further delays, increased workloads for the CSR, and ultimately, reduced customer satisfaction. In this regard, various technological solutions were developed in an attempt to streamline the process of handling customer inquiries related to financial matters. The solutions were designed to reduce the burden on the CSR, increase efficiency, and provide customers with faster and more reliable service. While such technologies represent significant advancements over manual processes, they too have certain limitations.

Typically, Interactive Voice Response (IVR) systems are introduced to automate certain aspects of customer service. The IVR system is designed to handle basic customer queries by using pre-recorded voice prompts and touch-tone key selections. The primary function of an IVR system is to interact with customers, gather basic information through keypad inputs, and route calls to the appropriate department or CSR based on the customer's needs. The introduction of the IVR system marked significantly automated customer interactions. By allowing the customers to navigate through a menu of options, the IVR systems reduced the need for human intervention in the initial stages of the customer inquiry. The IVR system not only helped to manage call volumes effectively but also provided the customers with a degree of self-service, enabling them to reach the appropriate department without having to speak to the CSR. The IVR systems speed up the process of connecting customers with the right resources, thereby improving overall efficiency.

However, the IVR systems are designed to handle basic and routine queries. The IVR systems were not equipped to access real-time financial data. The IVR system is unable to retrieve or provide that information. The lack of integration with real-time financial data systems meant that IVR systems could not provide the level of service required for more complex financial queries.

Moreover, another technological solution that emerged to address the growing need for automation in customer service is static chatbots. The chatbots are programmed to handle predefined queries by recognizing specific keywords or phrases and providing corresponding responses. However, the chatbots were also not integrated with real-time financial data systems. The chatbot was unable to fulfill the request because it did not have access to the necessary data. Instead, they provide a generic response, such as directing the customer to call a support line or visit a particular webpage. The chatbots only respond to queries that match the programmed keywords or phrases. If a customer asked a question in a way that the chatbot did not recognize, the chatbot would either fail to provide a meaningful response or redirect the customer to the CSR.

### BRIEF DESCRIPTION OF THE DRA WINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

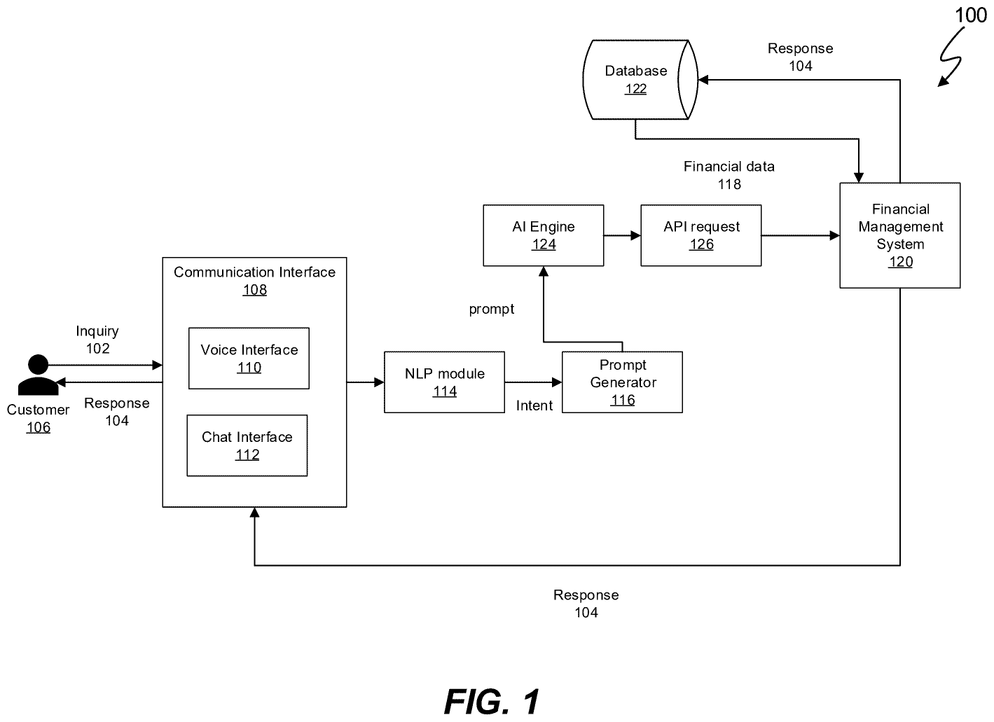

FIG. 1 depicts an exemplary response generation system for processing a customer inquiry related to financial information and responding to the customer.

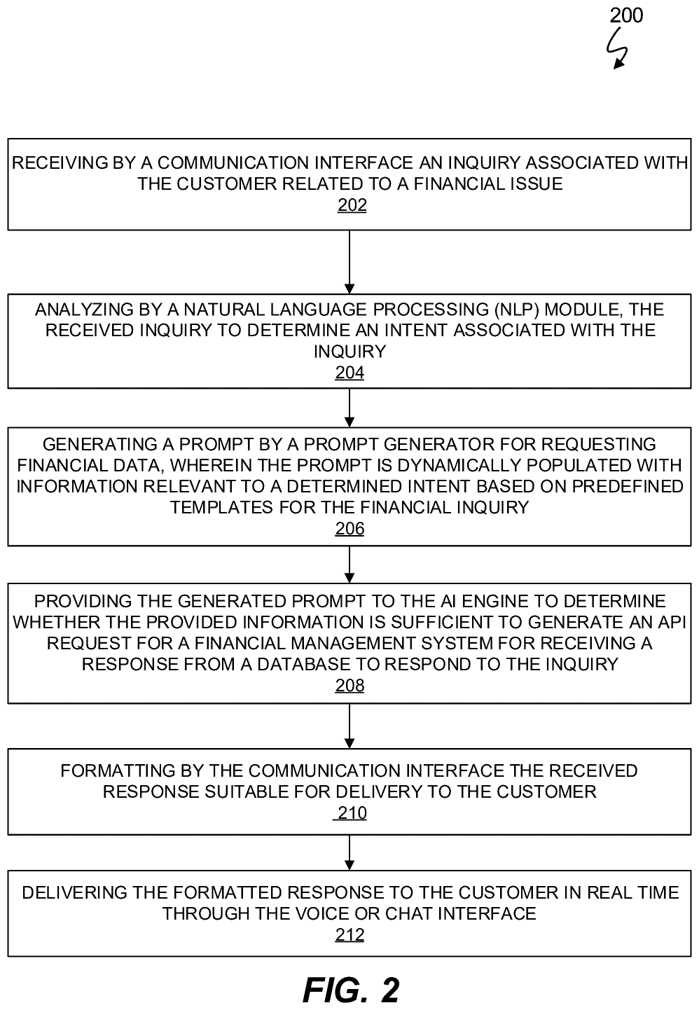

FIG. 2 depicts an exemplary response generation process utilized by the response generation system.

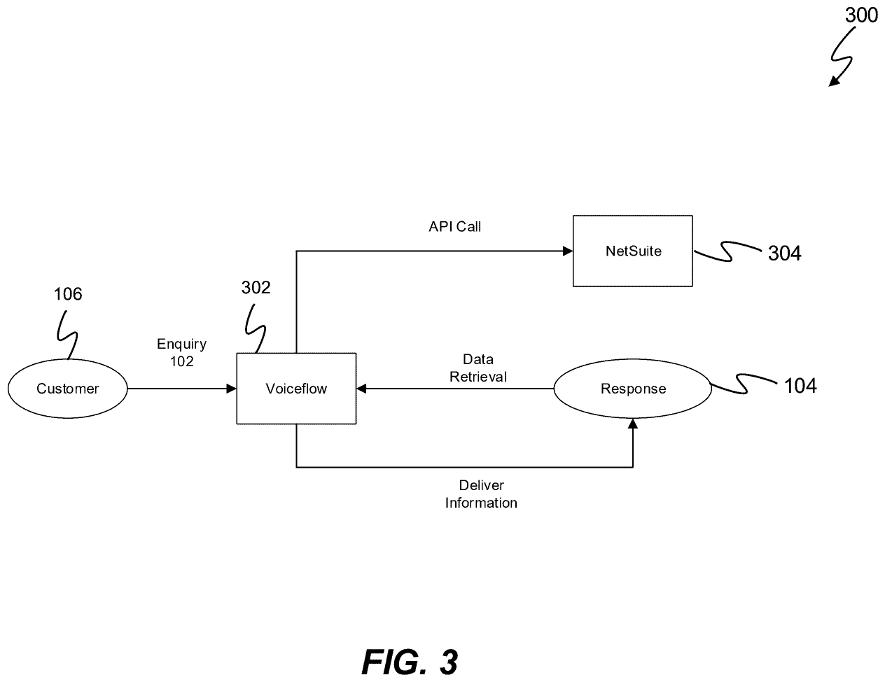

FIG. 3 depicts an inquiry handling process, which is an embodiment of the response generation process of FIG. 2.

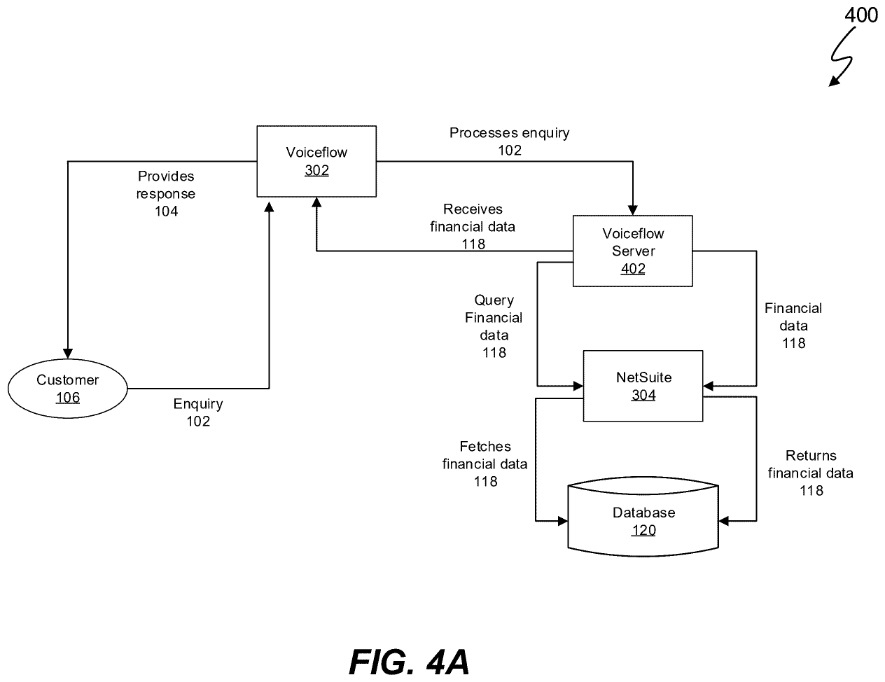

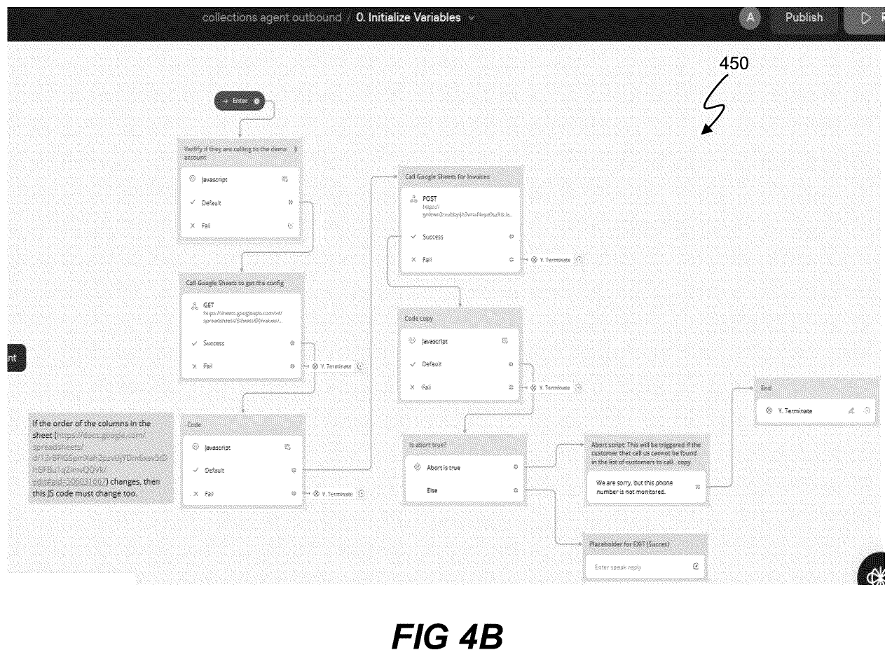

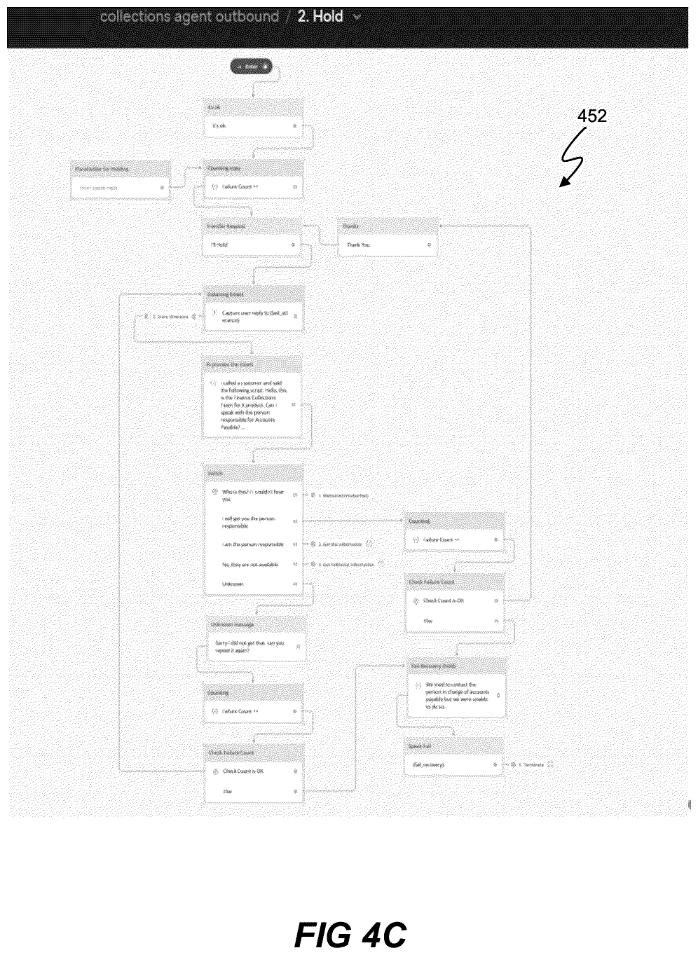

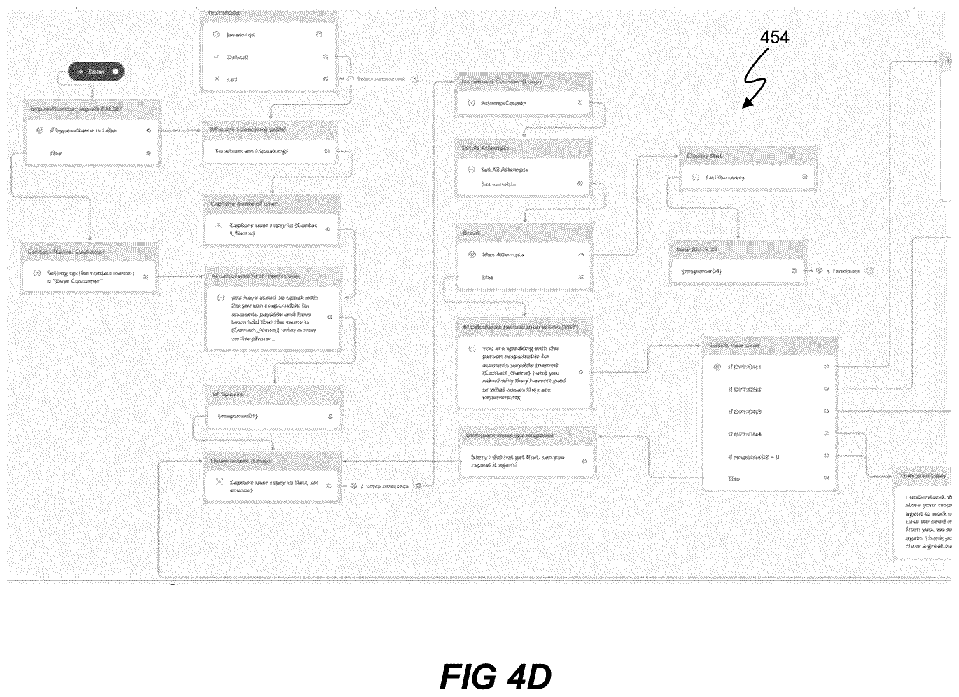

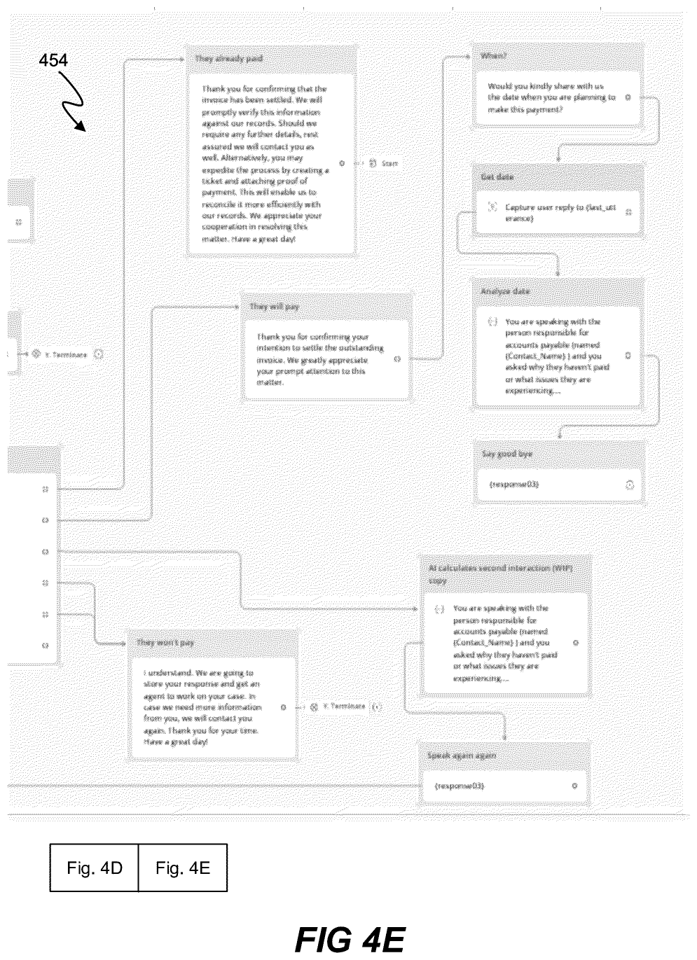

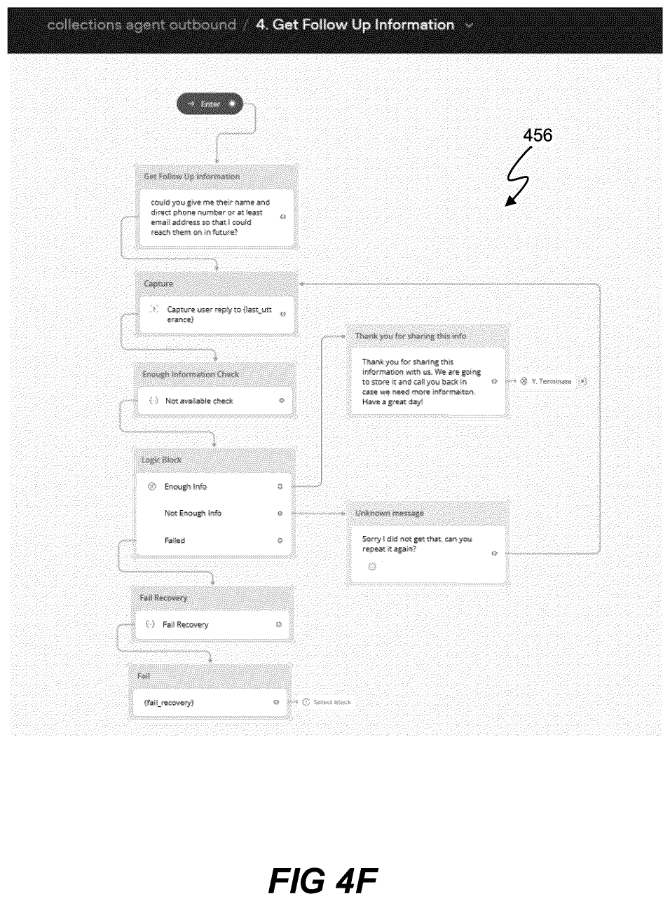

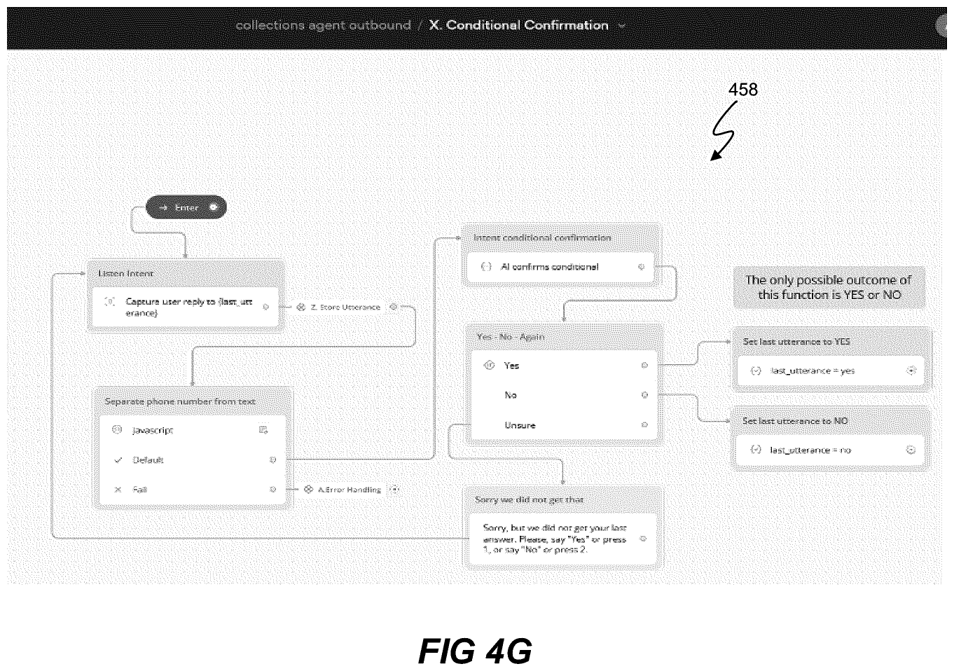

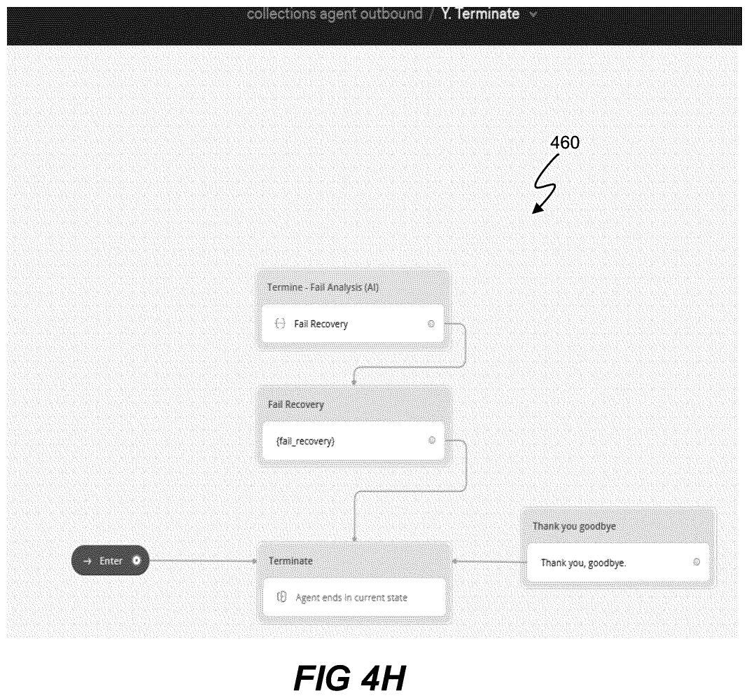

FIG. 4A depicts a data retrieval process, which is an embodiment of the response generation process of FIG. 2.

FIGS. 4B-4H depict exemplary voice flow workflows.

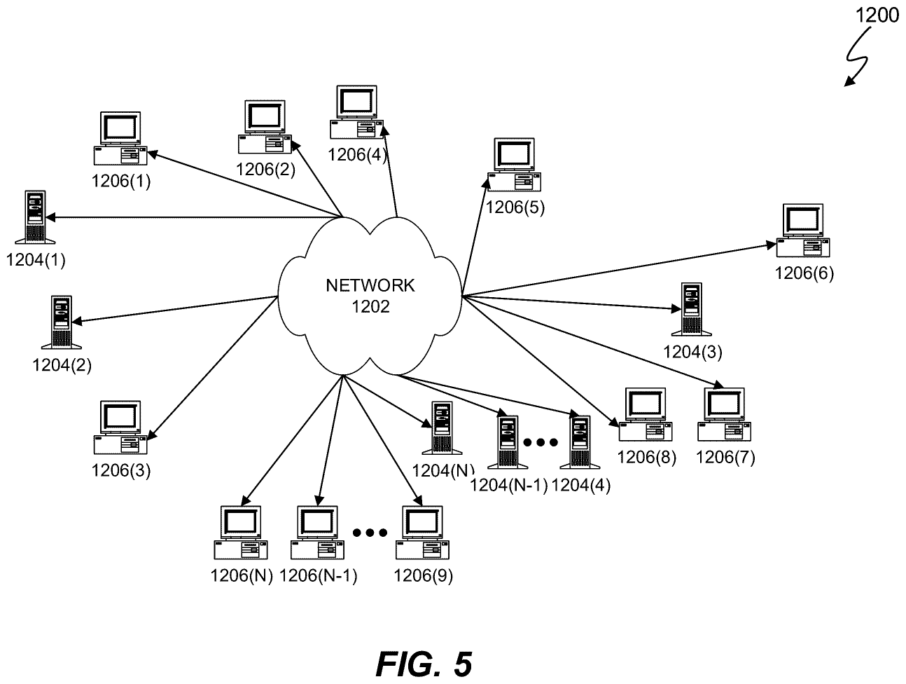

FIG. 5 depicts an exemplary network environment in which the system of FIG. 1 and the process of FIG. 2 may be practiced.

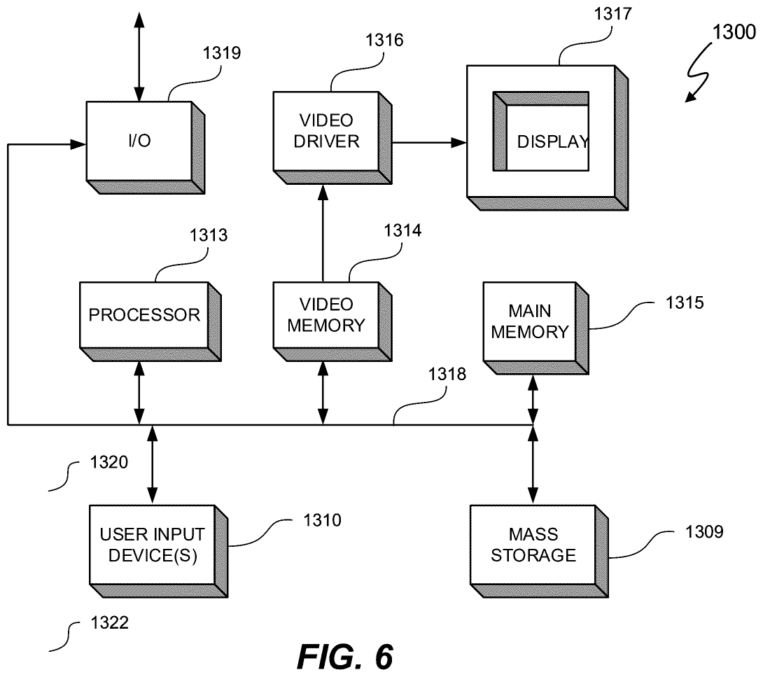

FIG. 6 depicts an exemplary computer system.

### DETAILED DESCRIPTION

A method and system for guiding an Artificial Intelligence (AI) engine to process customer inquiries related to financial information and respond to the customer. The system and method receive a customer inquiry related to a financial issue through a communication interface, which could be a voice or chat interface. The received inquiry is analyzed by a natural language processing (NLP) module to determine the intent associated with the inquiry. A prompt generator is used to dynamically generate a prompt for requesting financial data, with the prompt being populated with information relevant to the determined intent based on predefined templates for the financial inquiry. The generated prompt is provided to the AI engine, which analyzes the prompt to determine whether the provided information is sufficient to generate an application programming interface (API) request for a financial management system to receive a response from a database to respond to the inquiry.

Moreover, the AI engine determines that the information is sufficient and instructs the prompt generator to generate the prompt for initiating the API request to retrieve the required financial data. However, if the AI engine determines that the information is insufficient, it instructs the communication interface to request additional information from the customer. The communication interface then formats the received response as suitable for delivery to the customer, and the formatted response is delivered to the customer in real-time through the voice or chat interface.

The integration of Voiceflow with NetSuite API provides a unique solution that combines the flexibility and scalability of AI-driven conversational interfaces with the capability to perform specific financial transactions and inquiries in real-time. This integration addresses many of the disadvantages found in the alternatives, such as scalability issues, slow response times, and lack of real-time data access, making it a novel and non-obvious solution in the domain of financial technology and AI integration.

The method utilizes a conversational AI tool as the communication interface, which can manage voice and chat interactions. The financial management system may be an enterprise resource planning (ERP) system integrated with NetSuite. The customer inquiries handled specifically pertain to collections, including checking invoice balances, generating payment links, and providing customer statements. The conversational AI tool is configured to automatically initiate financial queries based on the real-time interactions of the customer. Furthermore, the communication interface dynamically updates the response based on additional customer input received during the conversation, with the conversational AI tool continuing to process subsequent financial queries. The communication interface may also allow the customer to select from multiple financial options during the conversation, and automatically adjust the API request based on the selected financial option. Additionally, the financial data may be retrieved from a database configured to store inquiries and responses and manage financial records including invoice balances, customer account details, and payment information.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not even recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

FIG. 1 depicts an exemplary response generation system 100 for processing customer inquiry 102 related to financial information to respond 104 to a customer 106. FIG. 2 depicts an exemplary response generation process 200 utilized by the response generation system 100.

Referring to FIGS. 1 and 2, in operation 202, receiving the customer inquiry 102 by a communication interface 108 associated with the customer 106 related to a financial issue. The customer inquiry 102 ranges from questions like checking account balances to understanding payment discrepancies or requesting detailed financial reports. The communication interface 108 acts as the gateway through which the customer inquiry 102 is received, interpreted, routed, and subsequently response is provided. Customer inquiry 102 is delivered through various channels such as via voice interaction and chat or text interaction. For voice interaction, a voice interface 110 is used and similarly for text or chat interaction a chat interface 112 is used. The voice interface 110 typically involves the customer 106 to call a service number, where customer inquiry 102 is handled. The customer inquiry 102 received via the voice interface 110 are characterized by their real-time nature, requiring immediate processing and quick responses. The chat interface 112 is predominantly text-based and includes interactions of the customer 106 through a website chatbox, a mobile app, or even messaging platforms such as WhatsApp or Facebook Messenger. Typically, the chat interface 112 offers a flexible and asynchronous form of communication, allowing the customer 106 to engage at their convenience while still expecting a timely response 104.

The customer 106 can initiate the customer inquiry 102 regarding the financial issue by selecting either the voice interface 110 or chat interface 112. The financial issue includes checking the status of an unpaid invoice, obtaining a payment link, verifying a recent transaction, or requesting a summary of recent account activity. Moreover, the customer 106 choice between the voice interface 110 and the chat interface 112 depends on several factors, including personal preference, the complexity of the issue, and the urgency of the request. For example, the customer 106 dealing with a time-sensitive matter might prefer the voice interface 110 to ensure direct communication, while the customer 106 who is multitasking might opt for the chat interface 112, which allows for a less immediate, yet still effective, exchange.

Once the customer 106 initiates the customer inquiry 102, the communication interface 108 captures and processes the inquiry 102. The communication interface 108 is designed to receive the customer inquiry 102 in a manner that is efficient and user-friendly. In the case of the voice interface 110, the customer 106 is prompted with a series of options to identify the nature of the issue. The interaction is guided by an automated voice menu, also known as an Interactive Voice Response (IVR) system, which asks the customer 106 to select from a range of predefined options. For example, the IVR system instructs the customer 106 to “Press 1 for billing inquiries, Press 2 for payment issues, or Press 3 for account information” allowing to categorize the inquiry and route it accordingly. For the chat interface 112, the customer 106 is greeted by an automated bot or live agent, prompting the customer 106 to describe the financial issue and analyze the customer 106 input in real-time, and categorize the customer inquiry 102 based on keywords or phrases. For example, if the customer 106 types, “I need to check the balance of my last invoice,” the communication interface 108 recognizes terms like “balance” and “invoice,” and understands the customer inquiry 102 relates to billing.

Once the communication interface 108 receives the customer inquiry 102, the communication interface 108 processes the inquiry 102. The communication interface 108 recognizes and adapts to the customer needs in real-time. The communication interface 108 is configured to manage the customer 106 expectations throughout the process. The communication interface 108 efficiently receives the customer inquiry 102 and provides timely feedback. The communication interface 108 enables data security and compliance and ensures that customer 106 details and corresponding information is handled in a manner that complies with relevant regulations, such as GDPR, PCI-DSS, or other industry-specific standards. Moreover, the communication interface 108 is designed to handle multiple customer inquiries 102 simultaneously.

In operation 204, analyzed by a natural language processing (NLP) module 114, the received inquiry 102 to determine an intent associated with the inquiry 102. The NLP module 114 understands, interprets, and responds to the intent associated with the inquiry 102 in a human language in a way that approximates human interaction. The NLP module 114 accurately determines the intent behind the inquiry 102 for providing the correct information in a timely manner. The intent of the customer inquiry 102 reflects the underlying need or purpose of the corresponding customer 106 for initiating the conversation, which may involve seeking information, requesting action, or resolving an issue. When the customer 106 submits the inquiry 102, through at least one of voice interface 110 or the chat interface 112, the NLP module 114 receives inquiry 102 as raw data. The NLP module 114 analyzes the received inquiry 102, breaks it down into its constituent parts, and interprets the meaning behind the words and phrases. Typically, the NLP module 114 relies on a combination of linguistic rules, statistical models, and machine learning techniques to perform the analysis.

The NLP module 114 text breaks down the inquiry 102 into individual words or phrases (tokens), and part-of-speech tagging, which identifies the grammatical roles of these tokens (e.g., nouns, verbs, adjectives). For example, in a query like “What is the balance on my last invoice?” the system would identify “What” as a question word, “balance” as the subject, and “my last invoice” as the object. These grammatical structures are crucial for the NLP module 114 to understand the relationship between different parts of the sentence and to determine what the customer 106 is asking for. Intent recognition by the NLP module 114 involves categorizing the inquiry 102 based on what the customer 106 wants to achieve. In simple terms, intent refers to the action that the customer 106 is expecting, such as providing information, executing a transaction, or resolving an issue. For example, common intents might include “Check Balance,” “Make Payment,” “Request Invoice,” or “Report Issue.”

In at least one embodiment, the NLP module 114 uses a combination of rule-based algorithms and machine learning model for identifying the intent. The rule-based algorithms rely on predefined patterns and keywords to match the input text to a specific intent. For example, if inquiry 102 contains words like “balance,” “due,” or “amount,” the NLP module 114 maps it to a “Check Balance” intent. The machine learning model allows the NLP module 114 to learn from past interactions and improve accuracy over time. The machine learning model can be trained on large datasets of customer interactions, enabling the NLP model 114 to recognize patterns in how intents are expressed across different contexts. In addition, the NLP module 114 also involves in detecting the emotional tone of the inquiry 102, which can provide additional clues about the intent or level of urgency of the customer 106. For example, if inquiry 102 contains frustration or negative sentiment, the NLP module 114 might prioritize quicker resolution. The intent recognition is crucial for delivering accurate and relevant responses and also for creating a seamless and satisfying customer experience.

The communication interface 108 comprises a conversational AI tool configured to manage the voice and chat interactions on the voice interface 110 and chat interface 112, respectively. The conversational AI tool is a software application that understands, processes, and responds to human language in a natural way. The conversational AI tool is capable of managing both voice and chat interactions. The conversational AI tool serves as a virtual assistant, capable of interpreting customer inquiry 102, engaging in meaningful dialogues, and providing the required information. In voice interactions by the voice interface 110 of the communication interface 108, the conversational AI tool uses speech recognition technology to convert spoken words into text. Once the speech is transcribed, the NLP module 114 is utilized to analyze the text to determine the intent behind the inquiry 102. In at least one embodiment, the voice interface 110 of the communication interface 108 utilizes a Twilio owned by Twilio Inc having headquarters in San Francisco, California. The Twilio is used to convert the voice interaction into text to provide the converted text to the NLP module 114. Moreover, the Twilio converts generated response 104 to voice for voice interaction with the customer 106. On the other hand, chat interactions on the chat interface 112 of the communication interface 108 the customer 106 types the inquiry 102, the conversational AI tool utilizes the NLP module 114 to understand the intent. The conversational AI tool is able to handle multiple customer interactions simultaneously.

Moreover, the integration of the conversational AI tool within the communication interface 108 allows for seamless transitions between voice and chat interaction. The conversational AI maintains context across the voice interface 110 and chat interface 112, ensuring that the customer 106 does not have to repeat or re-enter the inquiry 102. The consistency enhances the overall experience of the customer 106. Additionally, the conversational AI tools can be programmed to handle different languages and dialects, making the conversational AI tools operate globally. With language models capable of understanding and generating text or speech in multiple languages, the communication interface 108 can serve a diverse customer 106. When managing the customer inquiry 102 on voice interface 110 or chat interface 112, the conversational AI tools process information and generate response 104 instantaneously to meet customer 106 expectations. The conversational AI tools include a voiceflow owned by Voiceflow Inc., having headquarters in San Francisco, California. The voiceflow provides an interface for designing, prototyping, and building conversational interface. The voiceflow provides an interface for voice interface 110 and chat interface 112. The voiceflow offers pre-built templates to be allowed, presenting response 104 to the customer 106. The conversational AI tool is configured to automatically initiate financial queries based on real-time customer 106 interactions to engage with customer 106 and anticipate customer 106 needs during interaction. The conversational AI tool uses the NLP module 114 to understand customer inquiry 102, identifying when a financial query such as checking an invoice status, generating a payment link, or retrieving account details should be triggered. Once the intent is recognized, the conversational AI tool initiates the appropriate financial request by connecting to the financial management system to enhance the efficiency of the interaction and also delivers timely, accurate financial information.

In operation 206, generating a prompt by a prompt generator 116 for requesting financial data 118, wherein the prompt is dynamically populated with information relevant to a determined intent based on predefined templates for the financial inquiry 102. The prompt generator 116 is configured to generate the prompt to identify the relevant template from the predefined template based on customer inquiry 102. The predefined template is crafted to suit different categories of financial inquiries, such as invoice status, payment details, account summaries, and more. The predefined templates serve as structured frameworks that guide how the financial data 118 is requested from the financial management systems 120 like NetSuite, ensuring that the prompt is both accurate and aligned with the context of inquiry 102. Following is an exemplary prompt:

Prompt:
You are speaking with the person responsible for accounts payable (named
{
Contact_Name
}
) and you asked why they haven't paid or what issues they are experiencing. They
replied with: “
{
all_attempts
}
”. We know the following information about the account: The product is
{
[Product data placeholder inserted by the prompt generator]
}
and the balance outstanding is
{
[Balance data placeholder inserted by the prompt generator]
}

The idea is to categorize the answer given by the user. Rules: You will find either one of these three situations: —If they confirm that they already paid for the invoices, your answer must be (OPTION1). —If they promise that they will pay soon, your answer must be (OPTION2). —If they have doubts, they've made a new question or don't have access to the invoices, your answer must be (OPTION3). —If they confirm that they won't pay, your answer must be (OPTION4). —Make sure your answer only includes either (OPTION1), (OPTION2), (OPTION3), or (OPTION4). —If none of the apply, answer with 0

User:
you are a friendly Accounts Payable (collections) agent making phone calls for
{
[Product data placeholder inserted by the prompt generator]
}
and have called
{
[Company_Name data placeholder inserted by the prompt generator]
}
to enquire about a balance of
{
[Balance data placeholder inserted by the prompt generator]
}
. - Be brief, no more than 3-4 sentences, use proper phone etiquitte. - Pretend that you
are answering through the phone call, so do not answer like you are writing an email. -
You never describe or even mention the number of the invoice, just the balance (
{
[Balance data placeholder inserted by the prompt generator]
}
)

Once the relevant template is selected based on the identified intent, the prompt generator dynamically populates the template with information specific to the current conversation of customer 106. The dynamic population is crucial because each customer inquiry 102 is unique and can vary in the details provided or the level of specificity required. For example, if the customer inquiry 102 is about an outstanding invoice, the response 104 needs to include details such as the customer's account number, the invoice ID, or the billing period within the prompt. The prompt generator 116 extracts the information conversation or from customer associated database 122 and customer records, ensuring that the generated prompt contains all necessary details to accurately fulfill the request.

The use of predefined templates enhances the ability of the prompt generator 116 to create precise and relevant prompts. The predefined templates are designed with understanding of common financial interactions, incorporating both the language and data requirements specific to the financial inquiries 102. For example, a template for requesting invoice details include fields like “invoice number,” “customer ID,” and “date range.” When the prompt generator 116 identifies the intent, the prompt generator 116 automatically selects the relevant template and fills in the fields with contextually appropriate data to ensure that the prompt is well-formed and also contains all the necessary parameters to retrieve the correct financial data 118.

The prompt generator 116 also considers the conversation to ensure the prompt is aligned with the ongoing interaction. For example, if customer 106 has already provided certain information earlier in the conversation such as account number or the specific invoice they are inquiring about, the prompt generator 116 can reference the provided information.

In operation 208, providing the generated prompt to the AI engine 124, wherein the AI engine 124 analyzes the prompt to determine whether the provided information is sufficient to generate an application programming interface (API) request 126 for the financial management system 120 for receiving the response 104 from the database 122 to respond to the inquiry 102. The prompt generated by the prompt generator 116 based on the inquiry 102 is provided to the AI engine 124. The prompt serves as a structured query or request that encapsulates the information needed to retrieve specific financial data 118, such as invoice details, payment statuses, or account balances. The prompt is crafted to align with the intent of the customer 106, by analyzing the conversation using NLP module 114. The AI engine 124 determines whether the information within the prompt is comprehensive and contextually appropriate for generating the API request 126 to query the database 122. The AI engine 124 functions as the decision-making, when the AI engine 124 receives the prompt, it analyzes the content of the prompt to assess whether the prompt contains all the necessary elements needed for a successful query. The AI engine 124 involves evaluating the completeness, accuracy, and relevance of the information. For example, if customer 106 is asking for the balance of a specific invoice, the prompt includes essential details such as the invoice ID, customer account number, and perhaps even the date range in question.

The AI engine 124 parses the prompt to identify key data points. The data points are typically predefined based on the type of financial inquiry, with different fields required for different types of requests. For example, inquiry 102 about invoice details might require the invoice number, while inquiry 102 for payment information might need the payment reference or transaction ID. In addition, the AI engine 124 verifies the presence of required information. Once the AI engine 124 determines that the prompt is sufficiently complete and accurate, the API request 126 is generated.

Once the AI engine 124 determines that the information provided in the prompt is sufficient, the AI engine 124 proceeds to instruct the prompt generator to create the appropriate prompt for initiating the API request 124. The AI engine 124 translates the validated prompt into a structured query by converting the context-driven information from the conversation into technical parameters that align with the specific API endpoints of the financial management system 120. The API request 126 generated based on the determined intent. The API request 126 is configured to retrieve financial data 118 relevant to the inquiry 102 by sending a query to the database 122, the financial data 118 including at least one of an invoice balance, a customer statement, or a payment link. The API request 126 is a structured message sent from the communication interface 108 to asking for financial data 118. For example, when customer 106 asks for the balance of an outstanding invoice, the API request 126 retrieves the query in database 122 for the information.

The API requests 126 based on the determined intent by the NLP module 114 is configured to retrieve financial data 118 relevant to the inquiry 102. Once the intent is identified for example “check invoice balance,” “request customer statement,” or “generate payment link”. With the intent established, the intent is mapped to a predefined API endpoint that corresponds to the required financial data 118. For example, one API endpoint specifically for retrieving invoice balances, another API endpoint for generating customer statements, and yet another API endpoint for creating payment links. In at least one embodiment, the API request 126 is configured to retrieve financial data 118 and also data that is directly relevant to the customer inquiry 102.

The API request 126 is provided to the database 122 for the specific information, such as the balance of a particular invoice, a detailed customer statement, or a payment link that can be shared with the customer 106. After retrieving the financial data 118 and packages from the financial data 118 into as a response to the API request 126 in a format like JSON (JavaScript Object Notation), which is used by the communication interface 108 to parse and present to the customer 106. However, when the AI engine 124 determines that the information provided is insufficient to proceed with generating the API request 126, then the AI engine 124 instructs the communication interface 108 to request additional information from the customer 106. The communication interface 104 is directed by the AI engine 124 to frame specific, targeted questions aimed at clarifying or supplementing the missing details. For example, if customer 106 asks about their invoice balance without specifying the invoice number, the communication interface 108 responds with, “Could you please provide the invoice number for the balance you're inquiring about?”. The AI engine 124 may determine multiple pieces of missing information. In such a case, the communication interface 108 might break down the request into smaller, more manageable questions, guiding the customer 106 step-by-step until all relevant details are captured.

Receiving the API response for the corresponding API request 126 by the financial management system 120. The financial management system 120 is integrated with NetSuite. The NetSuite is used in financial management system 120 that serves as a comprehensive platform for managing financial activities such as invoicing, payments, financial reporting, and customer account management. The financial management system 120 accesses the financial data 118 through API request 126.

When the data corresponding to API request 126 is received by the financial management system 120, the NetSuite integrated in the financial management system 120 configured to generate the response 104. Once the secure connection is established, the API request 126 is sent to the appropriate endpoint within database 122. The NetSuite is designed around a set of modular endpoints, each corresponding to different types of the financial data 118. For example, there are endpoints for handling invoices, payments, customers, and other financial objects. The endpoint specified in the API request 126 determines how the API request 126 is handled within NetSuite. For example, if the inquiry 102 is related to retrieving the balance of a specific invoice, the API request 126 would be transmitted to an endpoint dedicated to the invoice. After the data retrieved by the API request 126 is received by NetSuite of the financial management system 120, the financial management system 120 processes to generate the response 104.

The financial management system 120 is an enterprise resource planning (ERP) system integrated with NetSuite. The ERP system is used to manage and automate processes, including finance and customer relationship management.

In operation 210, formatting by the communication interface 108 the received response 104 is suitable for delivery to the customer 106. The communication interface 108 formats the response 104 into a coherent, clear, and user-friendly response to ensure that the customer 106 can easily understand and act upon. The response 104 from the financial management system 120 arrives in a structured data format like JSON (JavaScript Object Notation). The format is designed for machine-to-machine communication and is not directly understandable by the customer 106. The response 104 generated is not ready for immediate delivery to the customer 106 because it lacks the natural language flow that is needed for effective communication. The communication interface 108 is configured to format the response 104 into the user friendly format. The formatting process involves converting the raw data into a clear, concise, and conversational message that aligns with the tone and style expected in interaction.

In at least one embodiment, the formatting follows the predefined templates or patterns that are designed to be easily understood by the customer 106. The templates are customized based on the type of inquiry 102. For example, if customer 106 asked about an invoice balance, the communication interface 108 corresponding template. The formatting allows the customer 106 to quickly grasp the information. The formatting of the response 104 ensures that the response 104 is delivered in a manner that is consistent with the communication interface 108. For example, in the voice interface 110, the communication interface 108 ensure that the response 104 is accurate and also concise and easy to understand when spoken aloud. In case of chat interface 112 the response 104 is visually appealing and allows the customer 106 to quickly locate the required information.

In addition, the communication interface 108 also considers language preferences, cultural nuances, and accessibility needs when formatting the response 104. For customer 106 who speak different languages or have specific localization requirements, the communication interface 108 is able to translate and format the response 104 accordingly. The formatting process also involves error handling and contingencies. If the financial management system 120 returns an incomplete or ambiguous response, the communication interface 108 must be able to format the response 104 clearly communicates the issue to the customer 106 and provides guidance on what steps to take next. In at least one embodiment, the communication interface 108 includes personalization elements to enhance engagement of the customer 106 by incorporating the customer's name, account details, or previous interactions.

In operation 212, delivering the formatted response 104 to the customer 106 in real time through the voice interface 110 or chat interface 112. Once the response 104 is formatted into a customer-friendly message, the response 104 is ready for delivery through the voice interface 110 or chat interface 108. The communication interface 108 transmits the response 104 quickly and accurately while maintaining the quality of the customer experience. For example, if customer 106 asks for the invoice balance, the communication interface 108 responds through the voice interface 110 with a statement like: “Your current balance for invoice 12345 is $500. In chat interface 112, real-time delivery involves transmitting the formatted response 102 in text form through messaging platforms, web chat widgets, or mobile applications. The response 104 is displayed instantly, to meet customer 106 expectations. The chat interface 112 displays the response 104 in a user-friendly format, including enhancements like clickable links, buttons, or even multimedia elements like images or videos, depending on the nature of the inquiry 102.

Prompt explanation: The prompt is designed for the AI engine 124 to handle inquiries 102 related to financial issues associated with the customer 106. Typically, receiving, via the communication interface 108, the inquiry 102 associated with the financial issue to a company's contact regarding the inquiry such as outstanding balance for a product and categorize the response 104 to the inquiry 102. The customer 106 provides one of four different responses such as: they have already paid, they will pay soon, they are confused or uncertain about the invoices, or they refuse to pay. The prompt specifies how the AI engine 124 responds based on these potential answers using preset responses labeled OPTION1, OPTION2, OPTION3, and OPTION4.

The communication interface 108 ensures that the interaction remains engaging and aligned with the expectations of the customer 106. For instance, a delay between the inquiry 102 and the response 104 can be frustrating and lead to a negative perception. The communication interface 108 ensures that communication, whether through voice interface 110 or chat interface 112, is encrypted and protected from unauthorized access.

For example, a customer 106 contacts the support via the chat interface 110 asking for the status of their latest invoice. The customer 106 initiates a chat saying, “What is the status of my latest invoice?”. The communication interface 108 captures the inquiry 102 and processes the inquiry 102 to determine the intent. The NetSuite of the financial management system 120 retrieves the invoice status and returns the information to the communication interface 108. The communication interface 108 formats the information into a coherent response 104 and replies to the customer 106, “Your latest invoice is currently unpaid with a balance of $450 due by the end of this month.”

Moreover, dynamically updating the response 104 based on additional customer 106 input during a conversation involves the conversational AI tool continuously processing and adapting the response 104 as the interaction evolves. As the customer 106 provides further details or asks follow-up questions, the conversational AI tool actively interprets the new input, adjusts the context of the conversation, and updates the response 104 in real-time. For example, if customer 106 initially asks about an outstanding invoice and then asks for a payment link, the conversational AI tool seamlessly transitions from retrieving the invoice balance to generating the requested link, ensuring that each response 106 is contextually relevant. The conversational AI tool able to manage dynamic flow relies on a real-time NLP module 114, and intent recognition to process multiple, related financial queries in sequence without losing track of the conversation. This capability enhances experience by delivering personalized and accurate responses while maintaining the natural flow of a human-like dialogue, ensuring the conversation remains cohesive and responsive to the evolving needs of the customer 106.

Furthermore, the database 122 is configured to store and manage generated response 104, invoice balances, customer account details, and payment information associated with each customer 106. The database 122 functions as a centralized repository that securely holds financial data 118, enabling efficient retrieval and processing of information in real-time. For example, when customer 106 requests details like an outstanding invoice or account statement, the database 122 instantly retrieves the relevant financial data 118, ensuring accurate and up-to-date information is available. In at least one embodiment, the database 122 is designed with robust indexing and query optimization techniques, allowing for the swift execution of complex inquiry 102 across datasets. The database 122 also supports dynamic updates and real-time synchronization, ensuring that any changes like payments received or adjustments to account balances are immediately reflected ensuring that the financial data 118 remains consistent, accurate, and readily accessible, supporting seamless operations.

FIG. 3 depicts an inquiry handling process 300, which is an embodiment of the response generation process of FIG. 2. As shown, the customer 106 with the inquiry 102 utilizes the voice interface 110 or the chat interface 112 of the communication interface 108 share the specific financial issues such as invoice status, payment details, and so forth to a voiceflow component 302. The voiceflow component 302 receives the inquiry 102. The voiceflow component 302 makes an API call to a NetSuite 304. The NetSuite 304 processes the received inquiry 102 and returns the required data. The voiceflow component 302 retrieves the data from the NetSuite 304. The received data by the voiceflow component 302 is formatted into a coherent response 104. The response 104 is delivered to the customer 106 in real-time. Following is an exemplary summary of integration of conversational AI with an ERP system to automate collections inquiries:
1. Receive User's conversation (call or chat).
   a. If call:
      i. Input to Twilio
      ii. Twilio voice-to-text conversion
   b. If chat, text available
2. Twilio obtains User's ID information such as Phone #, name, etc. from data source, such as Zendesk or NetSuite.
3. Provide text to Voiceflow
4. Voiceflow
   a. Voiceflow is guided through customized builds/paths to respond to the User in an attempt to obtain enough information to determine the User's intent.
   b. Using natural language processing (NLP) and artificial intelligence, Voiceflow attempts to determine the User's intent for contacting the company.
   c. Does Voiceflow have enough information to determine intent?
      i. If yes, provide information to a Prompt Generator.
      ii. If no, request additional information from the User or eventually send user to a human representative.
5. Prompt Generator

Generate Prompt to AI engine. The Prompt Generator has templates for multiple User Intents, such as invoice information, payment information, etc. The Prompt is populated with the User's conversation and information relevant to the determined intent. Below is an exemplary prompt to guide AI engine 124 to determined intent for the financial inquiry 102:

```
  You are speaking with the person responsible for accounts payable
(named
  {
  Contact_Name
  }
  ) and you asked why they haven't paid or what issues they are
experiencing. They replied with: “
  {
  all_attempts
  }
  ”. We know the following information about the account: The product is
  {
  Product
  }
  and the balance outstanding is
  {
  Balance
  }
  . The idea is to categorize the answer given by the user. Rules: You
will find either one of these three situations: - If they confirm that they
already paid for the invoices, your answer must be (OPTION1). - If they
promise that they will pay soon, your answer must be (OPTION2). - If they
have doubts, they've made a new question or don't have access to the
invoices, your answer must be (OPTION3). - If they confirm that they won't
pay, your answer must be (OPTION4). - Make sure your answer only includes
either (OPTION1), (OPTION2), (OPTION3), or (OPTION4). - If none of the apply,
answer with 0
  User:
  you are a friendly Accounts Payable (collections) agent making phone
calls for
  {
  Product
  }
  and have called
  {
  Company_Name
  }
  to enquire about a balance of
  {
  Balance
  }
  . - Be brief, no more than 3-4 sentences, use proper phone etiquitte. -
Pretend that you are answering through the phone call, so do not answer like
you are writing an email. - You never describe or even mention the number of
the invoice, just the balance (
  {
  Balance
  }
  )
```

### Provide Prompt to AI Engine, Such as OpenAI's GPT 4.

6. Based on the Prompt. AI Engine determines if the information provided in the Prompt is sufficient to obtain information from NetSuite, or other the data source, to properly respond to the User's intent.
   a. If yes, the AI Engine provides information to the Prompt Generator to generate a prompt to the AI to generate an API call to NetSuite to obtain the information to properly respond to the User.
   b. If not, the AI Engine instructs Voiceflow to respond to the user for more information or sends User to a human. Sending to a human can occur after a number of unsuccessful interactions with the user, or can be immediately sent to the human if the AI Engine determines that a successful interaction is too unlikely.
7. If yes in 6.a., the AI Engine generates all the parameters for the API call to NetSuite. For example:
   Error! Bookmark not defined. Provide the API call to NetSuite.
9. NetSuite retrieves the requested data.
10. Voiceflow provides a responsive text narrative with the retrieved data.
11. Twilio converts the text narrative to voice for a call communication with the User, or Voiceflow provides the text to the User for a chat communication.

FIG. 4A depicts a data retrieval process 400, which is an embodiment of the response generation process of FIG. 2. As shown, the customer 106 with the inquiry 102 utilizes the voice interface 110 or the chat interface 112 of the communication interface 108 share the specific financial issues such as invoice status, payment details and so forth to the voiceflow 302. The voiceflow 302 receives the inquiry 102 and provides the inquiry 102 to a voiceflow server 402. The voiceflow server 402 processes the inquiry 102 and sends a query to fetch the financial data 118 to the Netsuite 304. The Netsuite 304 fetches the financial data 118 from the database 120. The database 120 returns the financial data 118 to the Netsuite 304. The Netsuite 304 sends the financial data 118 to the voiceflow server 402. The voiceflow server 402 provides the financial data 118 to the voiceflow 302 and finally the voiceflow 302 returns the information to the customer 106.

FIGS. 4B-4H depict exemplary voiceflow workflows to, for example, handle the response received from the customer. Upon gathering the response, in the inquiry handling process 300, the voiceflow component 302 sends the response to VoiceFlow (Network), and VoiceFlow processes the by channeling the response through the designed workflow 450. FIG. 4B depicts initialization of voiceflow variables 450. FIG. 4C depicts a collection agent voiceflow hold workflow 452, waiting to gather the response from the responder. FIGS. 4D and 4E collectively depict a voiceflow workflow 454 to gather information. FIG. 4F depicts a voiceflow workflow 456 collecting follow-up information. FIG. 4G depicts a conditional confirmation voiceflow workflow 458. FIG. 4H depicts a voiceflow workflow 460 collecting conditional confirmation information from the user.

FIG. 5 is a block diagram illustrating a network environment in which a response generation system 100 and response generation process 200 may be practiced. Network 502 (e.g. a private wide area network (WAN) or the Internet) includes a number of networked server computer systems 504(1)-(N) that are accessible by client computer systems 506(1)-(N), where N is the number of server computer systems connected to the network. Communication between client computer systems 506(1)-(N) and server computer systems 504(1)-(N) typically occurs over a network, such as a public switched telephone network over asynchronous digital subscriber line (ADSL) telephone lines or high-bandwidth trunks, for example communications channels providing T1 or OC3 service. Client computer systems 506(1)-(N) typically access server computer systems 504(1)-(N) through a service provider, such as an internet service provider (“ISP”) by executing application specific software, commonly referred to as a browser, on one of client computer systems 506(1)-(N).

Client computer systems 506(1)-(N) and/or server computer systems 504(1)-(N) are specialized computer programmed to improve conventional computer systems to implement and utilize the response generation system 100 and response generation process 200. The type of computer system that can be specially programmed to implement and utilize the response generation system 100 and response generation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the response generation system 100 and response generation process 200 can be implemented using code stored in a tangible, non-transient computer readable medium and executed by one or more processors. In at least one embodiment, the response generation system 100 and response generation process 200 can be implemented completely in hardware using, for example, logic circuits and other circuits including field programmable gate arrays.

Embodiments of the response generation system 100 and response generation process 200 can be implemented on a computer system such as a special-purpose, special-programmed computer 600 illustrated in FIG. 6. Input user device(s) 610, such as a keyboard and/or mouse, are coupled to a bi-directional system bus 618. The input user device(s) 610 are for introducing user input to the computer system and communicating that user input to processor 613. The computer system of FIG. 6 generally also includes a non-transitory video memory 614, non-transitory main memory 615, and non-transitory mass storage 609, all coupled to bi-directional system bus 618 along with input user device(s) 610 and processor 613. The mass storage 609 may include both fixed and removable media, such as a hard drive, one or more CDs or DVDs, solid state memory including flash memory, and other available mass storage technology. Bus 618 may contain, for example, 32 of 64 address lines for addressing video memory 614 or main memory 615. The system bus 618 also includes, for example, an n-bit data bus for transferring DATA between and among the components, such as CPU 609, main memory 615, video memory 614 and mass storage 609, where “n” is, for example, 32 or 64. Alternatively, multiplex data/address lines may be used instead of separate data and address lines.

I/O device(s) 619 may provide connections to peripheral devices, such as a printer, and may also provide a direct connection to a remote server computer systems via a telephone link or to the Internet via an ISP. I/O device(s) 619 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 609, into main memory 615 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 613, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 615 is comprised of dynamic random access memory (DRAM). Video memory 614 is a dual-ported video random access memory. One port of the video memory 614 is coupled to video amplifier 616. The video amplifier 616 is used to drive the display 617. Video amplifier 616 is well known in the art and may be implemented by any suitable means. This circuitry converts pixel DATA stored in video memory 614 to a raster signal suitable for use by display 617. Display 617 is a type of monitor suitable for displaying graphic images.

The computer system described above is for purposes of example only. The response generation system 100 and response generation process 200 may be implemented in any type of computer system or programming or processing environment. It is contemplated that the response generation system 100 and response generation process 200 might be run on a stand-alone computer system, such as the one described above. The response generation system 100 and response generation process 200 might also be run from a server computer systems system that can be accessed by a plurality of client computer systems interconnected over an intranet network. Finally, the response generation system 100 and response generation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for guiding an Artificial Intelligence (AI) engine to process customer inquiries regarding financial information to provide a response to a customer comprising:
executing codes using one or more processors of a computer system to cause the computer system to perform operations comprising:
receiving, via a communication interface, an inquiry associated with a financial issue, wherein the inquiry is received via a voice or chat interface;
analyzing, via a natural language processing (NLP) module, the received inquiry to determine an intent associated with the inquiry;
generating a prompt, via a prompt generator, for requesting financial data, wherein the prompt is dynamically populated with information relevant to a determined intent based on predefined templates for the financial inquiry;
providing the generated prompt to the AI engine, wherein the AI engine analyzes the prompt to determine whether the provided information is sufficient to generate an application programming interface (API) request for a financial management system for receiving a response from a database to respond to the inquiry;
if the AI engine determines that the information is sufficient, then AI engine instructs the prompt generator to generate the prompt for initiating the API request to retrieve the required financial data; or
if the AI engine determines that the information is insufficient, then the AI engine instructs the communication interface to request additional information from the customer;
formatting by the communication interface the received response suitable for delivery to the customer; and
delivering the formatted response to the customer in real time through the voice or chat interface.

2. The method of claim 1 wherein the communication interface comprises a conversational AI tool configured to manage voice and chat interactions.

3. The method of claim 1 wherein the financial management system is an enterprise resource planning (ERP) system integrated with the NetSuite API.

4. The method of claim 1 wherein the customer inquiries pertain specifically to collections, including checking invoice balances, generating payment links, and providing customer statements.

5. The method of claim 1 wherein the conversational AI tool is configured to automatically initiate financial queries based on the real-time interactions of the customer.

6. The method of claim 1 further comprising:
dynamically updating the response based on additional customer input received during the conversation, wherein the conversational AI tool continues processing subsequent financial queries.

7. The method of claim 1 wherein the communication interface allows the customer to select from multiple financial options during the conversation, and automatically adjusts the API request based on the selected financial option.

8. The method of claim 1 wherein the financial data is retrieved from a database, the database is configured to store inquiry, response and manage financial records, including invoice balances, customer account details, and payment information.

9. A system for guiding an Artificial Intelligence (AI) engine to process customer inquiries regarding financial information to provide a response to a customer comprising:
one or more processors of a computer system; and
a memory, coupled to the one or more processors, that stores code and execution of the code by the one or more processors causes the computer system to perform operations comprising:
executing codes using one or more processors of a computer system to cause the computer system to perform operations comprising:
receiving, via a communication interface, an inquiry related to a financial issue associated with the customer, wherein the inquiry is received via a voice or chat interface;
analyzing, via a natural language processing (NLP) module, the received inquiry to determine an intent associated with the inquiry;
generating a prompt by a prompt generator for requesting financial data, wherein the prompt is dynamically populated with information relevant to a determined intent based on predefined templates for the financial inquiry;
providing the generated prompt to the AI engine, wherein the AI engine analyzes the prompt to determine whether the provided information is sufficient to generate an application programming interface (API) request for a financial management system for receiving a response from a database to respond to the inquiry;
if the AI engine determines that the information is sufficient, then AI engine instructs the prompt generator to generate the prompt for initiating the API request to retrieve the required financial data; or
if the AI engine determines that the information is insufficient, then the AI engine instructs the communication interface to request additional information from the customer;
formatting by the communication interface the received response suitable for delivery to the customer; and
delivering the formatted response to the customer in real time through the voice or chat interface.

10. The system of claim 9 wherein the communication interface comprises a conversational AI tool configured to manage voice and chat interactions.

11. The system of claim 9 wherein the financial management system is an enterprise resource planning (ERP) system integrated with the NetSuite API.

12. The system of claim 9 wherein the customer inquiries pertain specifically to collections, including checking invoice balances, generating payment links, and providing customer statements.

13. The system of claim 9 wherein the conversational AI tool is configured to automatically initiate financial queries based on the real-time interactions of the customer.

14. The system of claim 9 further comprising:
dynamically updating the response based on additional customer input received during the conversation, wherein the conversational AI tool continues processing subsequent financial queries.

15. The system of claim 9 wherein the communication interface allows the customer to select from multiple financial options during the conversation, and automatically adjusts the API request based on the selected financial option.

16. The system of claim 9 wherein the financial data is retrieved from a database, the database is configured to store inquiries, responses and manage financial records, including invoice balances, customer account details, and payment information.
